(19) United States
(12) Patent Application Publication
(10) Pub. No.: US 2006/0266178 A1
(43) Pub. Date: Nov. 30, 2006

(54) Punch Stripper

(75) Inventor: Robert C. Martin, Medina, OH (US)

Correspondence Address: LANE PUNCH CORPORATION, 281 LANE PARKWAY, SALISBURY, NC, 28146, US

(73) Assignee: LANE PUNCH CORPORATION, Salisbury, NC (US)

(21) Appl. No.: 10/908,719

(22) Filed: May 24, 2005

(51) Int. Cl. B26D 7/06

(52) U.S. Cl. 83/129; 83/139

(57) ABSTRACT

The punch stripper invention provides a design compatible with round or shaped punch points and flat, angular or irregular shaped surfaces to be punched. Using a bronze stripper insert machinable to suit the punch point shape and also three-dimensionally machinable to match the surface to be punched. The bronze stripper insert has graphite plugs to lubricate both the punch shank and the inner diameter of the insert sleeve as both components are used in close tolerance to guide the bronze stripper insert. An alignment pin is used in the insert sleeve to guide by a slot in the bronze stripper insert for anti-rotation. An elastomeric urethane spring is used for the stripping force required behind the bronze stripper insert, but always compressed in a parallel manor to maximize the life of the urethane. A retention plate is used to mount the stripper arrangement to a standard ball lock punch retainer with one or two screw style retention plates depending on clearance requirements.

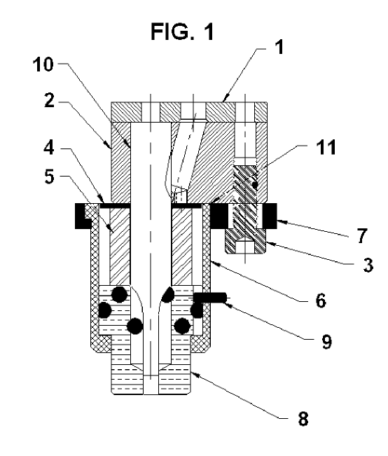

FIG. 1 illustrates, in cross section, the assembly of the stripper invention attached to a standard ball lock type punch retainer. The standard ball lock type punch retainer includes, 1. hardened retainer backing plate and 2. punch retainer body. The stripper invention consists of 3. attaching screw 4. backing washer 5. urethane spring 6. insert sleeve 7. retention plate 8. bronze stripper insert and 9. alignment pin.

In the following detailed description, general functionality will be clarified for the scope of the appended claims, but the description is not intended to be limiting as to size or shape of the components inasmuch as application of the invention is capable of taking on many variations and forms. The invention and design thereof utilizes specific improvements for particular applications unique to defined circumstances.

FIG. 1 illustrates that vital to the invention design is the guidance system for the 8. bronze stripper insert. The largest diameter of the bronze stripper insert is guided with minimal clearance by the inside diameter of the tempered steel 6. insert sleeve and also guided with minimal clearance on the hardened and ground diameter of the 10. punch shank. Graphite plugs exposed both inside and outside the guide diameter of the bronze stripper insert provide lubrication to the bearing diameters. Another major benefit of the invention design is that the wear surfaces are contained within the insert sleeve, minimizing ‘dirt’ generation, which could contaminate the workpiece being punched.

The 9. alignment pin in the insert sleeve guides the bronze stripper insert via a vertical slot in the largest diameter of the bronze stripper insert. The ability to control rotation of the bronze insert allows for the workpiece contacting face of the bronze stripper insert to be three dimensionally machined to match the form of the workpiece where contact is made. Current technological advancements in computer aided design and machining make it possible to transfer data and forms for machining which were not easily feasible in prior art applications.

A designed 11. flat on the insert sleeve prevents the sleeve from rotating inside the retention plate. The retention plate is attached to the standard ball lock type retainer by the 3. nylon-locking plug style alien head cap screw.

The 4. backing washer protects the 5. urethane spring from exposure to any edges on the punch retainer. The function of the 5. urethane spring differs from prior art applications only by the controlled parallel manor in which it is compressed and that it is protected from any unintended contact. The urethane spring (spool) can be easily replaced if needed without any other workpiece contact surfaces being altered.

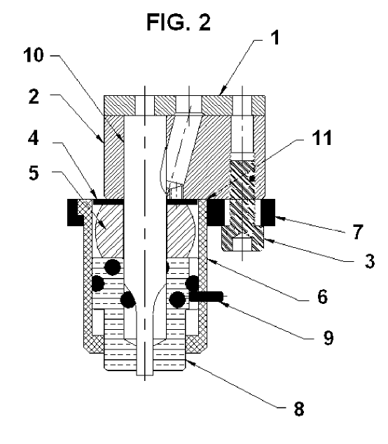

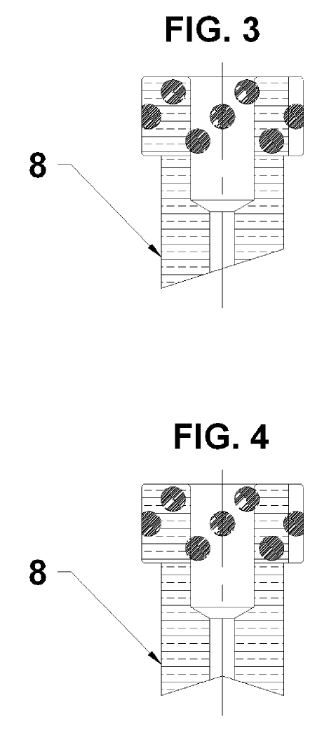

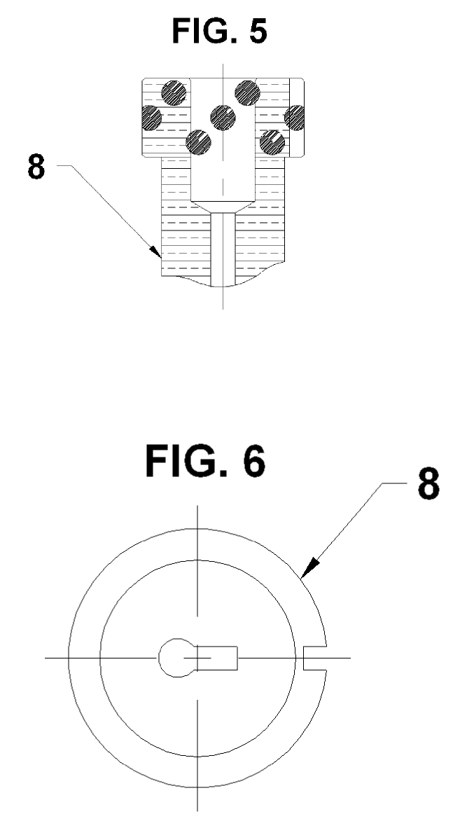

FIG. 2. illustrates, in cross section, the 8. bronze stripper insert compressing the 5. urethane spring as the workpiece is being punched. The urethane spring is always compressed in a parallel manor regardless of the shape of the surface of the workpiece whether angled, peeked or contoured. Workpiece surface variations are best shown in partial section views FIG. 3 angled, FIG. 4 peeked and FIG. 5 contoured.

FIG. 6 illustrates an end view of the 8. bronze stripper insert with an irregular shaped punch point machined into the stripping end. The variations of shape for punch points are not limited in any way and the closeness of fit between the bronze stripper insert and the punch point determines the quality of the workpiece distortion.

What is claimed is:

1. A stripper arrangement for a standard ball lock style punch retainer comprising of a bronze stripper insert component movable inside the bore of the insert sleeve, an insert sleeve, an elastomeric urethane spring, a backing washer to protect the urethane spring from unintended surface contact, a retention plate for attachment to the punch retainer, an alignment pin and a socket head cap screw for attachment.

2. The stripper arrangement as set forth in claim 1 wherein said insert sleeve having a precise flat which is seated inside the mating flat in the retention plate locking the stripper sleeve to eliminate radial movement and having a dowel hole for the alignment pin located on the same centerline position as the flat on said insert sleeve.

3. The stripper arrangement as set forth in claim 1 wherein said bronze stripper insert component has a precise slot, which guides on the alignment pin in the stripper sleeve, allowing the bronze stripper component to move only in a straight axis and not rotate in an radial motion.

4. The stripper arrangement as set forth in claim 1 wherein said bronze stripper insert component having graphite plugs both on the inside diameter and the outside diameter to lubricate both bearing surfaces inside the stripper sleeve and the shank of the punch which the stripper arrangement is installed upon.

5. The stripper arrangement as set forth in claim 1 wherein said elastomeric urethane spring can only be compressed in a parallel manor between the bronze stripper insert and the backing washer, inside the stripper sleeve protecting said urethane spring from any unintended contact with any surface or object.

6. The stripper arrangement as set forth in claim 1 wherein said bronze stripper insert component can be machined on the inside opening to precisely fit any irregular shape on the point of the punch to be stripped providing for no workpiece deformation.

7. The stripper arrangement as set forth in claim 1 wherein said bronze stripper insert component can be machined on the workpiece contacting face to mate with the workpiece providing full bearing support to the stripping action as the punch is withdrawn from the workpiece regardless of the shape of the surface of the workpiece.
